(19) United States
(12) Patent Application Publication
(10) Pub. No.: US 2014/0190951 A1
(43) Pub. Date: Jul. 10, 2014

(54) WELD DAMMING AND BACKING

(71) Applicant: KAWASAKI ROBOTICS (USA), INC., Wixom, MI (US)

(72) Inventors: Maximiliano A. Falcone, Ortonville, MI (US); John C. Siemer, Howell, MI (US); Zhengyuan Sam Yang, Farmington Hills, MI (US); Paul M. Betz, Scottsdale, AZ (US)

(73) Assignee: Kawasaki Robotics (USA), Inc., Wixom, MI (US)

(21) Appl. No.: 13/734,722

(22) Filed: Jan. 4, 2013

(51) Int. Cl. B23K 9/00

(52) U.S. Cl. CPC B23K 9/0026
USPC 219/137 R

(57) ABSTRACT

The present disclosure is directed to methods for damming and backing welds. In one embodiment, a method of welding a workpiece is provided in which the workpiece includes a first section, a second section, and a weld groove disposed therebetween. Opposing edges of the first and second sections are positioned adjacent to each other and at least partially form a bottom of the weld groove. A silicon dioxide weld dam is abutted against a terminal end of the workpiece relative to a weld direction. The weld dam is positioned at a weld joint termination point to prevent molten metal from flowing through a terminal end opening of the groove at the weld joint termination point. The first and second sections are welded together along opposing edges in the weld direction up to the weld joint termination point. Finally, the dam is removed, exposing the terminal end of the workpiece.

### BACKGROUND

In welding, the formation of a structurally sound weld at a particular location is desired. Steps may be taken to prevent molten metal applied by a weld process from flowing into undesired locations, as such flow may weaken the weld and damage components involved in the process. For example, molten metal applied to a workpiece having two sections may be blocked to sufficiently join the two sections together.

In some approaches, paddles comprised of copper are used to block the flow of molten metal in what may be an automated or manual weld process. In other approaches, ceramic plates are used to block molten metal flow.

Paddles comprised of copper, however, may transfer impurities into the weld and reduce its strength. Such impurities may have to be removed, for example by grinding and/or machining. The weld may then have to be reformed. On the other hand, ceramic plates may be limited to a single use, as they may shatter due to the surrounding heat produced by a weld. Moreover, this sensitivity limits the application of ceramic plates to long welds in which the time and length of the weld generates large amounts of heat, for example in the construction of ship and locomotive components.

### SUMMARY

The present disclosure is directed to methods for damming and backing welds. In one embodiment, a method of welding a workpiece is provided in which the workpiece includes a first section, a second section, and a weld groove disposed between the first and second sections. Opposing edges of the first and second sections are positioned adjacent to each other and at least partially form a bottom of the weld groove. A weld dam comprised of silicon dioxide is then abutted against a terminal end of the workpiece relative to a weld direction. The weld dam is positioned at a weld joint termination point in order to prevent molten metal from flowing through a terminal end opening of the groove at the weld joint termination point. The first and second sections are then welded together along their opposing edges in the weld direction up to the weld joint termination point. Finally, the dam is removed, exposing the terminal end of the workpiece.

In this way, the weld dam may prevent molten metal from flowing into undesired locations while aiding in the formation of structurally sound welds. Further, the use of silicon dioxide may reduce or prevent introducing contaminants to welds which might otherwise weaken the welds.

In a second embodiment, another method of welding a workpiece is provided in which the workpiece includes a first section, a second section, and a weld groove disposed between the first and second sections. Opposing edges of the first and second sections are positioned adjacent to each other and at least partially form a bottom of the weld groove. Bottom surfaces of the first and second sections are backed with a weld backer comprised of silicon dioxide in order to prevent molten metal from flowing below the bottom surfaces in a vertical direction. The first and second sections are then welded together along their opposing edges in the weld direction. Finally, the weld backer is removed, exposing the bottom surfaces of the first and second sections. The method may further include moving the weld backer in the weld direction as the first and second sections are welded.

### BRIEF DESCRIPTION OF THE DRAWINGS

FIG. 1 schematically shows a plan view of a weld environment in accordance with an embodiment of the present disclosure.

FIG. 2 shows an exemplary weld dam arrangement in accordance with an embodiment of the present disclosure.

FIG. 3A shows an open root weld arrangement in accordance with an embodiment of the present disclosure.

FIG. 3B shows an open root weld backing arrangement in accordance with an embodiment of the present disclosure.

FIG. 3C shows a plug weld backing arrangement in accordance with an embodiment of the present disclosure.

FIG. 4A shows a contoured weld backing arrangement in accordance with an embodiment of the present disclosure.

FIG. 4B shows a mandrel weld backing arrangement in accordance with an embodiment of the present disclosure.

FIG. 5 shows a combined weld dam and backing arrangement in accordance with an embodiment of the present disclosure.

FIG. 6 schematically shows an exemplary computing device that may be used as a robotic controller.

### DETAILED DESCRIPTION

The present disclosure is directed to the formation of structurally sound and uncontaminated welds in desired locations. As described in more detail below, molten metal applied to two sections of a workpiece is blocked with a weld dam comprised of silicon dioxide. The weld dam is removed after a predetermined amount of time in which the weld has sufficiently solidified. In another embodiment, molten metal is blocked with a weld backer, also comprised of silicon dioxide. The weld backer may be moved as a weld is applied.

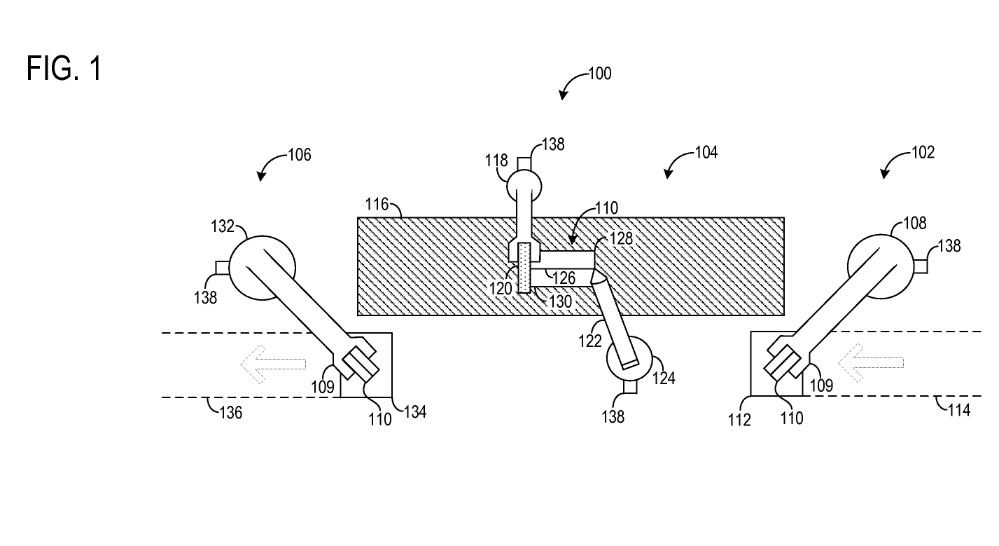

FIG. 1 schematically shows a plan view of a weld environment 100 configured to facilitate an automated weld process which may include manual aspects. As shown, weld environment 100 comprises three stages: a carry-in stage 102, a weld stage 104, and a carry-out stage 106. In totality, the stages are configured to carry in a workpiece to weld environment 100, apply a weld to the workpiece, and carry out the workpiece for further processing.

At carry-in stage 102, a carry-in robot 108 carries in a workpiece 110 for welding in weld environment 100. Workpiece 110 is simultaneously shown in carry-in stage 102, weld stage 104, and carry-out stage 106, though it will be understood that each instance of workpiece 110 may be a unique workpiece, with every workpiece substantially having the same material composition and dimensions. In other embodiments, workpieces may possess any suitable variety of dimensions according to the workpieces which may be welded and processed in weld environment 100. Workpieces may be carried in from an external location, or, for example, from a carry-in platform 112 configured to stage workpieces on a level surface and in a rotational orientation suitable for handling by carry-in robot 108. Further, carry-in platform 112 may be connected to an inbound conveyor 114 which may automatically transport workpieces into weld environment 100 from right to left and place them in the position shown on carry-in platform 112.

Carry-in robot 108 includes a grip 109 having a shape suited for gripping workpiece 110 at its lateral sides. Having attained a sufficient grip, carry-in robot 108 moves workpiece 110 via rotational and/or translational motion to a weld platform 116, which is configured to receive and support workpiece 110 during welding. As shown in FIG. 1, the reach of carry-in robot 108 is such that it places workpiece 110 at a right edge of weld platform 116. However, such reach may vary without departing from the scope of this disclosure, and in some embodiments the reach of carry-in robot 108 may be such that it places workpieces substantially at a center of weld platform 116.

Weld platform 116 provides a supportive, level surface on which workpieces may be received and welded. In some embodiments, weld platform 116 is a static surface which does not impart motion to a workpiece. In other embodiments, weld platform 116 is a conveyor which receives a workpiece at the right end, pulls the workpiece leftward toward a center of the platform, and finally pulls the workpiece toward a left end of the platform after welding, at which point the workpiece may be carried out for further handling. Weld platform 116 may include a plurality of jigs (not shown) to which workpieces may be affixed for increased stability. Moreover, weld platform 116 may comprise a plurality of lanes (not shown) which each support a workpiece. In this way, the throughput of weld environment 100 may be increased by allowing multiple workpieces to be welded simultaneously.

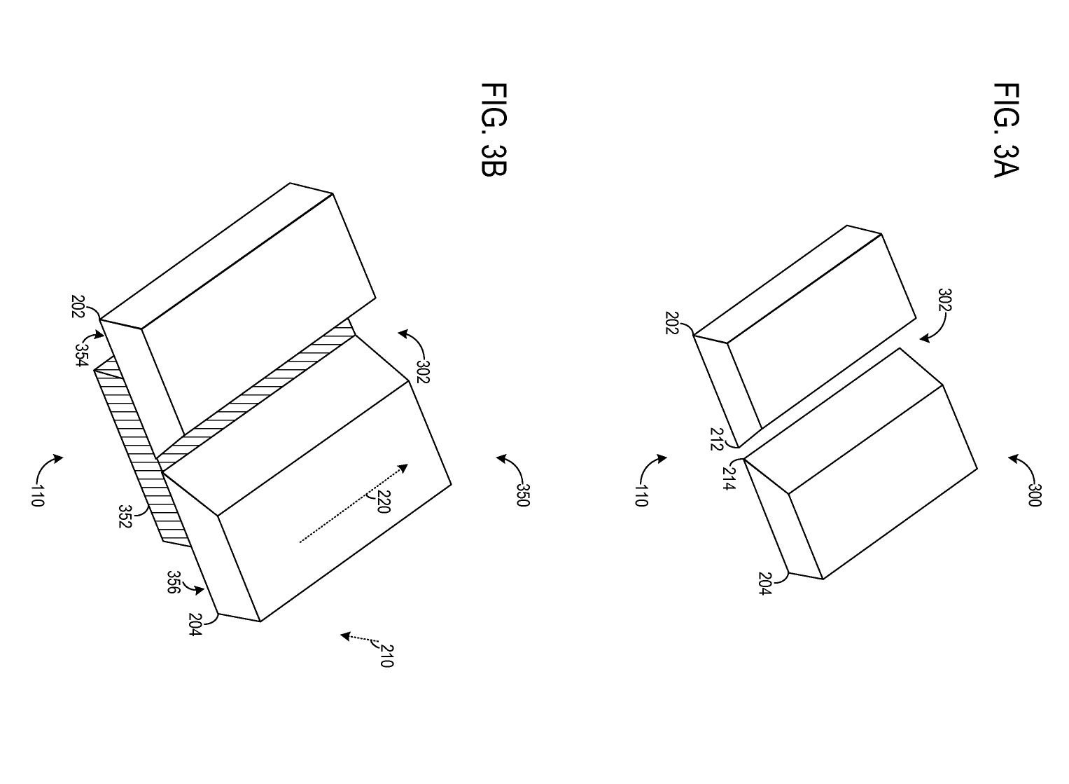

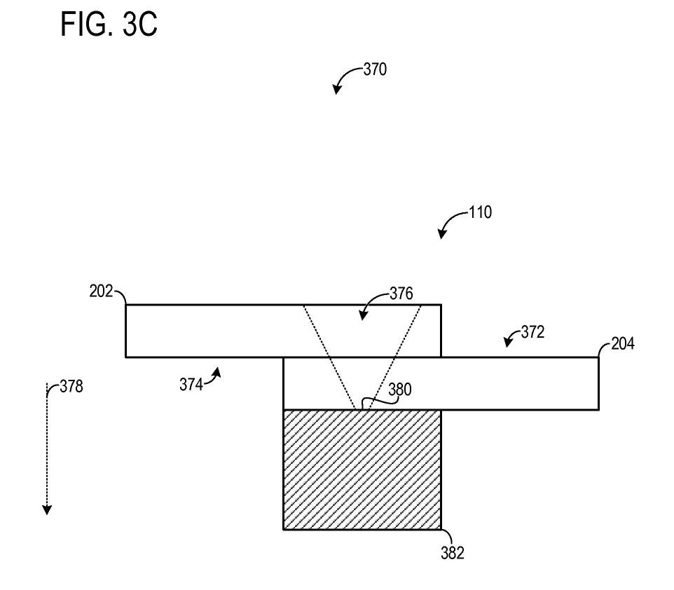

Once workpiece 110 is placed at the center of weld platform 116, the weld process may be initiated at weld stage 104. FIG. 1 shows an abutment robot 118 gripping and abutting a weld dam 120 against a terminal end of workpiece 110. Weld dam 120 is configured to prevent molten metal applied by a weld torch 122 from flowing into undesired locations. As the weld process begins, weld torch 122 moves, via rotational, translational, sinusoidal, or any other suitable motion provided by a weld robot 124 to which it is coupled, from right to left along a weld groove 126. Weld robot may have the capability to span the vertical length of weld platform 116 and its lanes, if they are included. The molten metal applied by weld torch 122 along weld groove 126 joins together a first section 128 and a second section 130 of workpiece 110. Once weld torch 122 reaches the terminal end of workpiece 110, the weld process is terminated. Molten metal applied by the process is prevented from flowing beyond this terminal end by the abutment of weld dam 120. Alternatively or additionally, workpieces may be backed and molten metal prevented from flowing beyond their bottom surfaces in weld environment 100, described in further detail below with reference to FIGS. 3-5. It will also be appreciated that multiple weld robots may be included in weld environment 100, and, in the embodiment in which weld platform 116 includes multiple lanes, one weld robot may be provided per lane.

After deposition of molten metal by weld torch 122 has completed, the molten metal is allowed to set and cool for a predetermined amount of time, thereby ensuring that a sufficient structural integrity is attained. Sufficient solidification of the molten metal is also ensured. Once the predetermined amount of time is reached, abutment robot 118 removes weld dam 120 from the terminal end of workpiece 110. Operation then proceeds to carry-out stage 106 whereat a carry-out robot 132 removes workpiece 110 via its grip 109 from weld platform 116 and places workpiece 110 on a carry-out platform 134. Like carry-in platform 112, carry-out platform 134 may be connected to an outbound conveyor 136 which carries welded workpieces out of weld environment 100 for further processing. Similarly, carry-out robot 132 may be configured like carry-in robot 108 but suited for removing workpieces from weld platform 116.

The above described robots, including carry-in robot 108, abutment robot 118, weld robot 124, and carry-out robot 132, may be articulated robots. The robots may have three degrees of freedom, including rotational and translational degrees of freedom, though this number may be varied without departing from the scope of this disclosure. The robots may further engage in any other suitable types of motion, including sinusoidal motion. The reach of each robot may also be varied, for example depending on whether weld platform 116 is a static surface or a conveyor. The robots may be servo-controlled with a spatial accuracy and repeatability on the order of better than 1 millimeter, for example 0.3 millimeters. It will be appreciated that such spatial accuracy and repeatability is provided as a non-limiting example, and that these parameters may be varied without departing from the scope of this disclosure. In some examples, these parameters may vary depending on the types of welds and/or workpieces welded in weld environment 100. Carry-in and carry-out robots 108 and 132 are also shown as non-limiting examples; conveyor (e.g., a carry-in conveyor and a carry-out conveyor) and transfer devices may instead be used to implement their functions. Further, carry-in and carry-out robots 108 and 132 may be omitted from weld environment 100 and their functions carried out by human operators without departing from the scope of this disclosure.

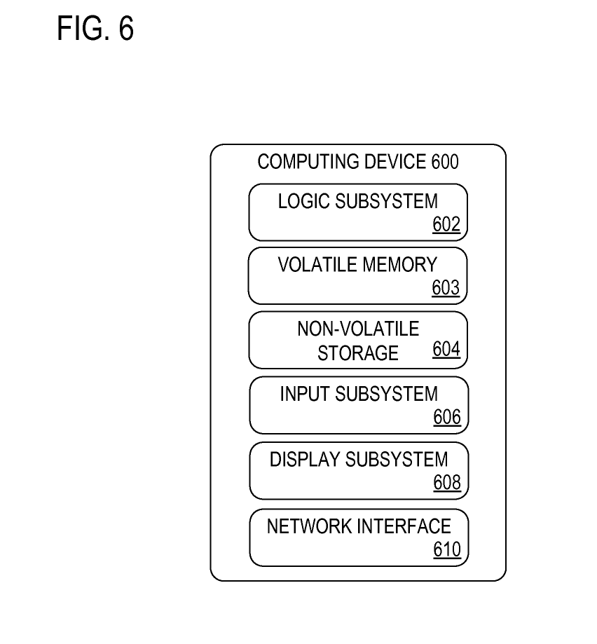

As shown in FIG. 1, each robot includes a controller 138 configured to carry out the motions and routines described above, together facilitating a weld process. Alternatively, the robots may be commonly coupled to a single controller. Moreover, control functions may be distributed across specific controllers. For example, one controller may control abutment robot 118 and weld robot 124, while another controller may control carry-in and carry-out robots 108 and 132. Such controller(s) may be configured to implement a continuous path control scheme in which each point along a desired path (e.g., the path extending from carry-in platform 112 to weld platform 116) is specified. An exemplary controller in accordance with the present disclosure and configured to carry out the motions and routines described herein is described below with reference to FIG. 6.

Weld robot 124 may use any suitable techniques for achieving proper placement of weld torch 122 during the weld process. Such techniques include tactile sensing and visual sensing, the latter accomplished for example with the inclusion of a laser sensor (not shown). Moreover, such techniques may be augmented with the formation of a compensation table. In this approach, a test workpiece identical to workpiece 110 is sensed using a test robot (not shown) having the same sensor(s) included in weld robot 124 (e.g., tactile and/or laser sensor(s)). Position errors are then generated and used to generate the compensation table, which is accessed by controller 138 of weld robot 124 during the weld process. In this way, accurate welding may be achieved by referencing previously generated errors to minimize current errors.

The above discussed techniques may be used with various welding technologies, including arc welding, gas welding, energy beam welding, or other techniques. Thus, weld torch 122 may be a welding device such as a gas torch, electric arc unit, laser beam unit, ultrasound unit, etc. Specific types of welding include gas metal arc welding (GMAW), metal inert gas (MIG) welding, tungsten inert gas (TIG) welding, oxyacetylene welding (OAW), gas tungsten arc welding (GTAW), submerged arc welding (SAW), etc. However, it will be appreciated that these examples are non-limiting and that other suitable techniques may be used without departing from the scope of this disclosure.

Weld environment 100 may include additional components not shown in FIG. 1. For example, weld environment 100 may include an inspection robot configured to determine the spatial orientation of an inbound workpiece before being processed and welded by weld robot 124. The inspection robot may include a laser sensor to determine such spatial orientation. Weld environment 100 may also include an inspection robot configured to inspect and measure a welded workpiece before being processed by carry-out robot 132. Still further, a plurality of shields may be included in weld environment 100 to prevent splashing and propagation of molten metal to undesired locations. Although the weld process implemented by weld environment 100 is shown as proceeding from right to left, the weld process may instead proceed from left to right without departing from the scope of this disclosure. In such an embodiment, for example, weld robot 124 may be configured to weld workpieces from left to right.

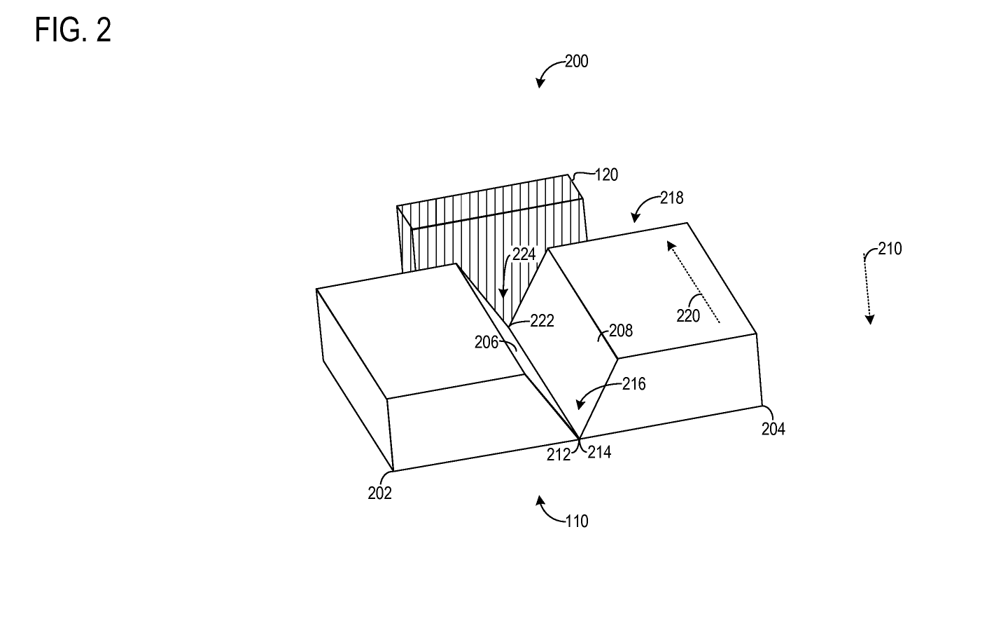

Turning now to FIG. 2, an exemplary weld dam arrangement 200 is shown, further illustrating how weld dam 120 may be abutted against workpiece 110 in weld environment 100. In the illustrated example, workpiece 110 comprises a first section 202 and a second section 204. First and second sections 202 and 204 may be comprised of metal (e.g., steel) or any other type of material suitable for welding. As shown, first and second sections 202 and 204 are oriented such that they resemble rectangular blocks with laterally-oriented opposing faces 206 and 208 which slope outward as the sections are traversed downward in a vertical direction 210. Opposing faces 206 and 208 truncate with opposing edges 212 and 214, which, in the illustrated example, are positioned adjacent each other and at least partially form a bottom of a weld groove 216. It is in the space provided by weld groove 216 that welding of workpiece 110 and its sections 202 and 204 is carried out. It will be understood that the opposing edges may be placed in contact with each other, substantially apart, or any distance therebetween without departing from the scope of this disclosure.

Weld dam arrangement 200 further includes weld dam 120 abutted against a terminal end 218 of workpiece 110 and first and second sections 202 and 204. In this example, first and second sections 202 and 204 are aligned. In this case, weld dam 120 may be abutted and made flush against terminal end 218, thereby preventing undesired molten metal flow. However, in other scenarios first and second sections 202 and 204 may be misaligned, for example due to a difference in their inherent dimensions or alignment error. Weld dam 120 may then be prevented from being flush with first and second sections 202 and 204. In this case, weld dam arrangement 200 may benefit from both weld damming and backing, as further described below with reference to FIGS. 3-5.

Weld dam 120 may be disposed at terminal end 218 of workpiece 110, relative to a weld direction 220 at a weld joint termination point 222. Such an arrangement may facilitate a weld process in which first and second sections 202 and 204 are welded together along opposing edges 212 and 214 by moving a weld torch (e.g., weld torch 122), weld tip, or other welding device through weld groove 216 along weld direction 220. The welding device may then stop at weld joint termination point 222 where weld dam 120 prevents molten metal produced by the weld from flowing through a terminal end opening 224 of the weld groove. In other words, weld dam 120 prevents molten metal from flowing beyond an intended weld region that would otherwise be open.

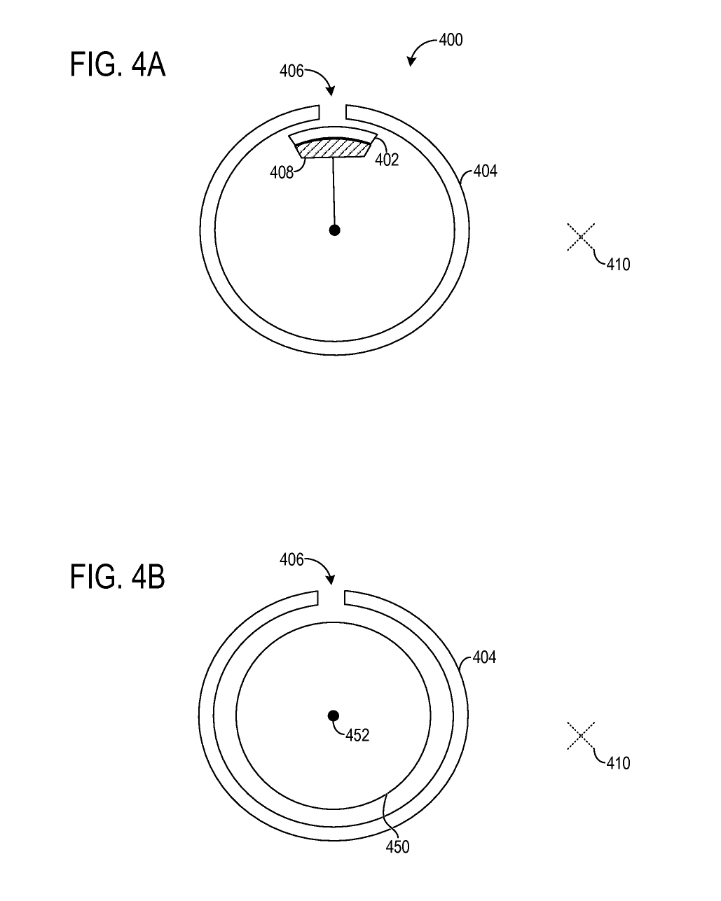

In the illustrated embodiment, weld dam 120 is shown as a rectangular block, as its geometric shape substantially corresponds to terminal end 218 of workpiece 110 and first and second sections 202 and 204, increasing its ability to prevent undesired molten metal flow. Other shapes and geometric configurations are possible, however, without departing from the scope of this disclosure. Weld dams may be provided with surfaces or contours matching terminal ends of workpieces with non-rectangular shapes. As non-limiting examples, convex or concave weld dams may be provided. Such embodiments are described in further detail below with reference to FIG. 4.

Weld dam 120 is comprised of silicon dioxide, which may present potential advantages over dams comprised of other materials. Dams comprised of copper, for example, may transfer copper into the weld before it has fully cooled, contaminating the weld with impurities and potentially degrading the weld's structural integrity. The welding process may then have to expend time and resources removing such impurities, for example via machining and re-welding. In contrast, because of its material composition of silicon dioxide, weld dam 120 may reduce or eliminate impurity transfer into the weld. As such, welding processes in accordance with the present disclosure need not expend the time and resources to remove impurities and reform the weld.

Weld dam 120 may further be reused for multiple welds due to its material composition. Ceramic dams, for example, are generally limited to a single use per weld and are generally more brittle and sensitive to heat inherent in the weld process. As such, the use of weld dam 120 may reduce cost and waste during the weld process.

In the illustrated example, weld dam 120 is comprised of silicon dioxide with a purity of 99.995%. However, it will be appreciated that the potential advantages described above may be achieved with other levels of purity. Moreover, silicon dioxide may be mixed with other select substances while still achieving the benefits described above.

After a weld has completed—in other words, has traversed the length of opposing edges 212 and 214 while depositing molten metal and reached weld joint termination point 222, weld dam 120 may be removed for potential reuse, exposing terminal end 218 of workpiece 110 and first and second sections 202 and 204. In one approach, weld dam 120 is removed after a predetermined period of time. Such a period of time, for example, may allow molten metal applied by a weld torch (e.g., weld torch 122), weld tip, etc. to substantially solidify to a point at which it will no longer flow beyond weld joint termination point 222. As a non-limiting example, the predetermined amount of time is 1.5 seconds. In another approach, weld dam 120 is allowed to release by its own weight after a longer period of time. In this example, weld dam 120 may become adhered to terminal end 218 of workpiece 110 and/or the terminal end of molten metal. After the longer period of time, the molten metal may solidify to the extent that the gravitational force acting on weld dam 120 overcomes the diminishing adherence force, allowing the weld dam to release by its own weight. As one non-limiting example, the longer period of time is 40 seconds. In weld environment 100, a detached weld dam may be handled by abutment robot 118 or another suitably configured robot.

Turning now to FIG. 3A, an open root weld arrangement 300 is shown. Open root weld arrangement 300 includes workpiece 110 and first and second sections 202 and 204. However, in this example opposing edges 212 and 214 are placed adjacent each other and spaced a predetermined amount apart. Open root weld arrangement 300 may be referred to as an “open root” or “open root joint”, and the type of weld applied to such an open root as a “complete joint penetration weld”. Opposing edges 212 and 214 thus form at least partially a bottom of an open root 302. Molten metal may applied to the length of open root 302, joining together first and second sections 202 and 204. Open roots and complete joint penetration welding may be applicable to structural welds and fabrication of lengthy components—e.g., crane booms and ship and locomotive components.

Moving now to FIG. 3B, a weld backing arrangement 350 is shown. Weld backing arrangement 350 includes a weld backer 352 backed against bottom surfaces 354 and 356 of first and second sections 202 and 204 and against open root 302. In the illustrated example, weld backer 352 has a rectangular geometry with a length that spans the lengths of first and second sections 202 and 204. As welding is carried out, weld backer 352 may facilitate the formation of a weld with appropriate geometry and sufficient structural integrity in open root 302. Further, weld backer 352 may prevent molten metal applied by the weld from flowing below bottom surfaces 354 and 356 of first and second sections 202 and 204 in vertical direction 210.

While the approach described above may be appropriate for certain types of applications, it may be less desirable when applied to the fabrication and welding of lengthy components—a longer weld backer would be required, increasing cost and the difficulty of the weld process. In such a case, weld backer 352 may have a length substantially less than the length of a workpiece to which it is applied. To compensate, weld backer 352 may then be moved manually or automatically along weld direction 220 as welding is carried out. The weld backer may be moved in predetermined amounts along the weld direction, interrupted by periods of non-movement to allow the weld to solidify to a desired extent. Alternatively, the weld backer may be moved continuously at a rate that facilitates the sufficient solidification of the weld. Upon successful completion of a weld, weld backer 352 may be removed, exposing bottom surfaces 354 and 356.

Turning now to FIG. 3C, a plug weld backing arrangement 370 is shown. In this embodiment, a top surface 372 of second section 204 of a metal workpiece is abutted against a bottom surface 374 of first section 202 of the metal workpiece. In other words, first section 202 is stacked on top of second section 204. As shown, the terminal ends of each section are mismatched, though the terminal ends may be aligned. Faces of each section may also be mismatched or aligned. A weld groove 376 is disposed in workpiece 110, extending downward in a vertical direction 378. In this example, weld groove 376 extends downward and completely throughout the vertical thickness of first and second sections 202 and 204, though weld groove 376 may instead extend partially throughout second section 204 without departing from the scope of this disclosure. Weld groove 376 may be formed by any suitable methods (e.g., machining) or may be disposed earlier during the formation of workpiece 110. Weld groove 376 possesses a cone-like geometry, though any suitable geometries may be used, including cylindrical and rectangular geometries. In plug weld backing arrangement 370, a weld device (e.g., weld torch 122) may commence the weld process by applying molten metal beginning at a starting point 380 and proceed upward, along a direction opposite to vertical direction 378. The weld may terminate, for example, once the tip end of the weld device reaches a top surface of first section 202. As shown, a weld backer 382 is abutted against a bottom surface of second section 204, providing support and stability to the weld process. In embodiments like that shown in FIG. 3C, weld backer 382 further aids in the formation of a structurally sound weld disposed in weld groove 376 and prevents molten metal from flowing beyond the bottom surface of second section 204 along vertical direction 378, as weld groove 376 extends throughout the entire vertical thickness of second section 204. It will be appreciated that various aspects of plug weld backing arrangement 370 may be varied without departing from the scope of this disclosure while still facilitating the formation and/or backing of plug welds, including the alignment of the terminal ends of first and second sections 202 and 204, the placement of weld backer 382, and the formation and depth of weld groove 376.

As described above with reference to weld dam 120, weld backer 352 may possess alternative geometries to that shown FIG. 3B. Turning to FIG. 4A, a contoured weld backing arrangement 400 is shown, including a contoured weld backer 402 backing a pipe 404. Pipe 404 has a contour root 406 to which molten metal may be applied. Contoured weld backer 402 is profiled and curved to match the geometry of pipe 404 and contour root 406, thereby preventing molten metal applied during a weld process from propagating downward and contacting a lower part of pipe 404. It will be appreciated, however, that the contoured geometry shown in FIG. 4A is a non-limiting example and that virtually any profiled geometry is possible without departing from the scope of this disclosure.

Contoured weld backer 402 may be moved manually or automatically during the weld process. As one non-limiting example, contoured weld backer 402 may be moved automatically with a tractor device 408 along a direction 410, extending into FIG. 4A. FIG. 4B shows another example in which a weld backer forms a mandrel backer 450 configured to support pipe 404 during a weld process. Mandrel backer 450 may be connected to an axis 452 extending along direction 410 and configured to support mandrel backer 450. The profiled backing approaches illustrated in FIGS. 4A and 4B may be applicable to the fabrication long components such as those in the welding of ships, mining equipment, structural equipment, and farming implements, for example.

Like weld dam 120, weld backers 352, 402, and 450 are comprised of silicon dioxide, thus the potential advantages described above apply, including non-contamination. The material composition of weld backers 352, 402, and 450 may be further advantageous when moved as molten metal is applied, for example when welding lengthy components. Weld backers comprised of ceramics, for example, may not be used in this scenario as their material composition tends to cause cracking in the ceramic material itself. Consequently, such ceramic weld backers may not be reused.

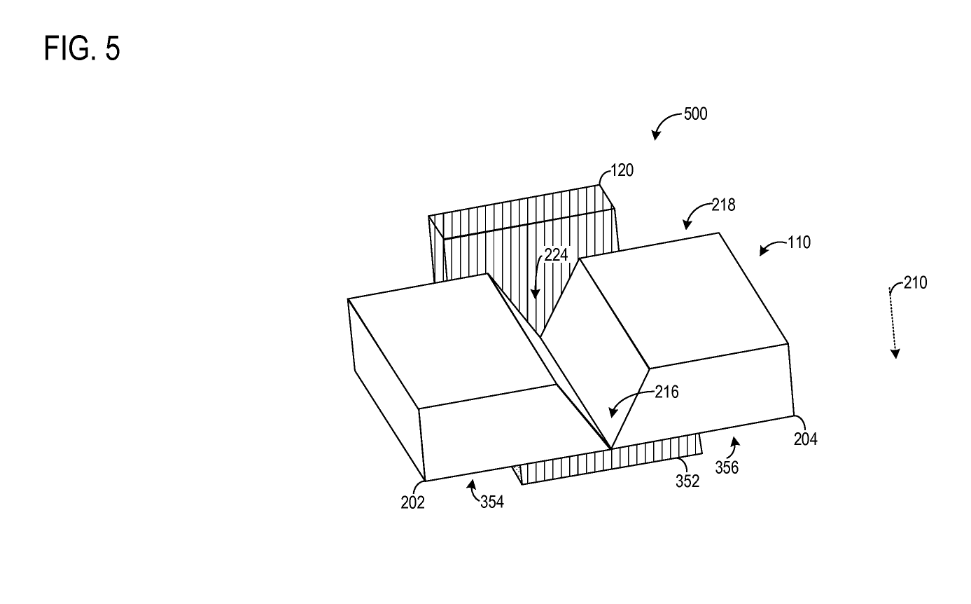

Turning now to FIG. 5, a combined weld dam and backing arrangement 500 is shown. In this embodiment, the dam and backing approaches described above are combined. Weld dam 120 is abutted against terminal end 218 of workpiece 110, preventing molten metal from flowing through terminal end opening 224 of weld groove 216. Weld backer 352 is also backed against bottom surfaces 354 and 356 of first and second sections 202 and 204, preventing molten metal from flowing below the bottom surfaces in vertical direction 210 and facilitating the formation of a weld with appropriate geometry and sufficient structural integrity.

Such a combined approach may implement separate weld dams and backers, or may combine the two to form a contiguous weld dam and backer. The latter approach may be applicable to welds of smaller lengths. In this example, molten metal flowing beyond weld joint termination point 222 due to misalignment of the terminal ends of first and second sections 202 and 204 may be caught by the backing portion of the combined weld dam and backer.

As described above, weld backer 352 may be moved automatically, for example with tractor device 408. Placement and movement of weld dam 120 may also be automated, for example with abutment robot 118 or by mounting the weld dam to a paddle device. Such approaches may be used individually for the embodiment in which weld dams and backers are separated. Conversely, a tractor device may be used to accomplish automation for the approach in which a combined, contiguous weld dam and backer is used.

Moving now to FIG. 6, a non-limiting embodiment of a computing device 600 is schematically shown. Computing device 600 may be used to carry out the methods described herein, and may further be used as robotic controllers (e.g., as controller 138 in weld environment 100). Computing device 600 is shown in simplified form. It will be understood that virtually any computer architecture may be used without departing from the scope of this disclosure. In different embodiments, computing device 600 may take the form of a mainframe computer, server computer, desktop computer, laptop computer, tablet computer, home-entertainment computer, network computing device, gaming device, mobile computing device, mobile communication device (e.g., smart phone), etc.

Computing device 600 includes a logic subsystem 602, volatile memory 603, and a non-volatile storage subsystem 604. Computing device 600 may also include a display subsystem 608, input subsystem 606, and network interface 610, and/or other components not shown in FIG. 6.

Logic subsystem 602 includes one or more physical devices configured to execute instructions. For example, the logic subsystem may be configured to execute instructions that are part of one or more applications, services, programs, routines, libraries, objects, components, data structures, or other logical constructs. Such instructions may be implemented to perform a task, implement a data type, transform the state of one or more components, or otherwise arrive at a desired result.

The logic subsystem may include one or more processors configured to execute software instructions. Additionally or alternatively, the logic subsystem may include one or more hardware or firmware logic machines configured to execute hardware or firmware instructions. The processors of the logic subsystem may be single-core or multi-core, and the programs executed thereon may be configured for sequential, parallel or distributed processing. The logic subsystem may optionally include individual components that are distributed among two or more devices, which can be remotely located and/or configured for coordinated processing. Aspects of the logic subsystem may be virtualized and executed by remotely accessible, networked computing devices configured in a cloud-computing configuration.

Volatile memory 603 may include devices such as RAM that are used to temporarily contain data while it is being processed by the logic subsystem. It will be appreciated that data stored in volatile memory 603 is typically lost when power is cut.

Non-volatile storage subsystem 604 includes one or more physical devices configured to hold data and/or instructions in a non-volatile manner to be executed by the logic subsystem to implement the methods and processes described herein. Non-volatile storage subsystem 604 may include computer readable media (e.g., CD, DVD, HD-DVD, Blu-Ray Disc, FLASH memory, EEPROM, ROM, etc.), which may include removable media and/or built-in devices that hold instructions in a non-volatile manner, and thus continue to hold instructions when power is cut to the device. Non-volatile storage subsystem 604 may include other storage devices such as hard-disk drives, floppy-disk drives, tape drives, MRAM, etc.).

In some embodiments, aspects of the instructions described herein may be propagated over a communications medium, such as a cable or data bus, in a transitory fashion by a pure signal (e.g., an electromagnetic signal, an optical signal, etc.) that is not held by a physical device for a finite duration.

The terms “module,” “program,” and “engine” may be used to describe a software aspect of computing device 600 implemented to perform a particular function. In some cases, a module, program, or engine may be instantiated via logic subsystem 602 executing instructions held by non-volatile storage subsystem 604, using portions of volatile memory 603. It will be understood that the terms “module,” “program,” and “engine” may encompass individual or groups of executable files, data files, libraries, drivers, scripts, database records, etc.

Display subsystem 608 may include one or more displays, which may be integrated in a single housing with the remaining components of the computing device 600, as is typical of smart phone applications, laptop computers, etc., or may be separated and connected by a wired or wireless connection to the computing device, as is typical of desktop computers. The displays may be touch-sensitive for input, in some examples.

Input subsystem 606 may comprise or interface with one or more user-input devices such as a keyboard, mouse, touch screen, etc.

Network interface 610 may be configured to communicatively couple computing device 600 with one or more other computing devices via a computer network, such as the Internet, utilizing a wired or wireless connection.

It is to be understood that the configurations and/or approaches described herein are exemplary in nature, and that these specific embodiments or examples are not to be considered in a limiting sense, because numerous variations are possible. The embodiments described above and the embodiments illustrated in the drawings serve as examples of the variety of different devices. The subject matter of the present disclosure includes all novel and nonobvious combinations and subcombinations of the various configurations, features, functions, and/or properties disclosed herein, as well as any and all equivalents thereof.

1. A method of welding a workpiece, the workpiece including a first section, a second section, and a weld groove between the first and second sections, the method comprising:
positioning opposing edges of the first and second sections adjacent each other, the opposing edges at least partially forming a bottom of the weld groove;
abutting a weld dam comprised of silicon dioxide against a terminal end of the workpiece relative to a weld direction at a weld joint termination point in order to prevent molten metal from flowing through a terminal end opening of the groove at the weld joint termination point;
welding the first and second sections together in the weld direction along the opposing edges up to the weld joint termination point; and
removing the dam to expose the terminal end of the workpiece.

2. The method of claim 1, wherein removing the dam includes removing the dam after a predetermined period of time.

3. The method of claim 1, wherein removing the dam includes allowing the dam to release via gravitational forces.

4. A method of welding a workpiece, the workpiece including a first section, a second section, and an open root between the first and second sections, the method comprising:
positioning opposing edges of the first and second sections adjacent each other, the opposing edges at least partially forming a bottom of the open root;
backing bottom surfaces of the first and second sections with a weld backer comprised of silicon dioxide in order to prevent molten metal from flowing below the bottom surfaces in a vertical direction;
welding the first and second sections together in a weld direction along the opposing edges; and
removing the weld backer to expose the bottom surfaces.

5. The method of claim 4, wherein welding the first and second sections includes moving the weld backer in the weld direction.

6. The method of claim 5, wherein moving the weld backer includes moving the weld backer in predetermined amounts interrupted by periods of non-movement.

7. The method of claim 5, wherein the weld backer is moved continuously at a rate that facilitates sufficient solidification of a weld.

8. The method of claim 5, wherein the weld backer is moved with a tractor device.

9. The method of claim 4, wherein the weld backer has a length that spans lengths of the first and second sections.

10. The method of claim 4, wherein the weld backer is rectangular.

11. The method of claim 4, wherein the weld backer is curved.

12. The method of claim 4, wherein the weld backer is a mandrel.

13. The method of claim 4, further comprising:
abutting a weld dam comprised of silicon dioxide against a terminal end of the workpiece relative to a weld direction at a weld joint termination point in order to prevent molten metal from flowing through a terminal end opening of the groove at the weld joint termination point; and
removing the weld dam to expose the terminal end of the workpiece.

14. The method of claim 13, wherein removing the dam includes removing the dam after a predetermined period of time.

15. The method of claim 13, wherein removing the dam includes allowing the dam to release via gravitational forces.

16. The method of claim 4, wherein the weld dam and weld backer are contiguous.

17. A weld environment, comprising:
an abutment robot configured to abut one or more of a terminal end with a weld dam and a back surface with a weld backer of a workpiece, the workpiece comprising a first section and a second section; and
a weld robot configured to weld together the first and second sections along a weld groove;
wherein the weld dam and weld backer are comprised of silicon dioxide.

18. The weld environment of claim 17, further comprising a carry-in robot or a carry-in conveyor configured to carry the workpiece into the weld environment, a carry-out robot or a carry-out conveyor configured to carry the workpiece out of the weld environment for further processing, and a weld platform configured to support the workpiece during welding.

19. The weld environment of claim 18, wherein the abutment robot, weld robot, carry-in robot, and carry-out robot each include a controller.

20. The weld environment of claim 17, wherein:
a top surface of the second section is abutted against a bottom surface of the first section;
the weld groove extends downward in a vertical direction throughout the first section and at least partially through the second section; and
a position of the weld backer corresponds to the weld groove.
